(19) United States
(12) Patent Application Publication
(10) Pub. No.: US 2025/0388135 A1
(43) Pub. Date: Dec. 25, 2025

(54) SEAT SYSTEM

(71) Applicant: TOYOTA BOSHOKU KABUSHIKI KAISHA, Aichi-ken (JP)

(72) Inventors: Hiroshi TSUJI, Aichi-ken (JP); Fumitoshi AKAIKE, Aichi-ken (JP); Seiya NISHIMURA, Aichi-ken (JP)

(73) Assignee: TOYOTA BOSHOKU KABUSHIKI KAISHA, Aichi-ken (JP)

(21) Appl. No.: 19/238,849

(22) Filed: Jun. 16, 2025

(30) Foreign Application Priority Data
Jun. 19, 2024 (JP) 2024-098617

(51) Int. Cl. B60N 2/12; B60N 2/02; B60N 2/34; B60N 2/62; B60N 3/00

(52) U.S. Cl. CPC B60N 2/12; B60N 2/62; B60N 3/002; B60N 2002/0204; B60N 2002/0216; B60N 2002/022; B60N 2/34

(57) ABSTRACT

A seat system includes a front seat including a first seat portion and a second seat portion, a rear seat arranged in a front-rear direction and including a third seat portion and a fourth seat portion, a posture switching mechanism configured to implement a first switching for selectively switching to a rear end flat seat portion of the front seat facing the rear seat, and a second switching for selectively switching to a front end flat seat portion of the rear seat facing the front seat, and a front-rear slide mechanism configured to slide at least one of the front seat and the rear seat in the front-rear direction relative to a floor to align the rear end flat seat portion of the front seat to be flush with the front end flat seat portion of the rear seat in the front-rear direction.

### CROSS-REFERENCE TO RELATED APPLICATIONS

This application is based on and claims priority under 35 USC 119 from Japanese Patent Application No. 2024-098617 filed on Jun. 19, 2024, the entire content of which is incorporated herein by reference.

### TECHNICAL FIELD

The present disclosure relates to a seat system including a front seat and a rear seat that are arranged in a front-rear direction.

### BACKGROUND ART

There has been known a technique of aligning seat portions of two seats without a gap to expand a seat surface in the related art.

For example, JP2023-152046A discloses a seat system in which a cushion and a backrest are adjustable in angle relative to a floor in a vehicle interior, and an entire seat is slidable relative to the floor of a vehicle.

In such a seat system, as one of a plurality of usage modes, a backrest of a front seat tilted to be horizontal is flush with a cushion of a rear seat without a gap (see FIG. 4 of JP2023-152046A). In this usage mode, the horizontal backrest of the front seat is flush with the cushion of the rear seat in a front-rear direction, and a seat surface spanning the front seat and the rear seat is formed.

However, in the technique of JP2023-152046A, to expand the seat surface spanning the front seat and the rear seat, it is only possible to further make a seating portion of the front seat flush with a backrest of the rear seat in the front-rear direction, which may result in poor variation.

Therefore, an object of the present disclosure is to provide a seat system that can provide more variations in forming a flat seat surface spanning a front seat and a rear seat.

### SUMMARY OF INVENTION

To solve the above problem, the seat system according to the present disclosure has following configurations.

A first aspect of the disclosure provides a seat system including a front seat and including a first seat portion constituting an upper half portion of a backrest and a second seat portion constituting a lower half portion of the backrest, a rear seat arranged in a front-rear direction, and including a third seat portion constituting a seating portion and a fourth seat portion constituting an ottoman, a posture switching mechanism configured to implement a first switching for selectively switching to a rear end flat seat portion of the front seat facing the rear seat by making a the first seat portion constituting an upper half portion of a backrest of the front seat flush with a the second seat portion constituting a lower half portion of the backrest of the front seat in the front-rear direction and folding the first seat portion downward relative to the flat second seat portion, and a second switching for selectively switching to a front end flat seat portion of the rear seat facing the front seat by making a the third seat portion constituting a seating portion of the rear seat flush with a the fourth seat portion constituting an ottoman in the front-rear direction and folding the fourth seat portion downward relative to the flat third seat portion, and a front-rear slide mechanism configured to slide at least one of the front seat and/or the rear seat in the front-rear direction relative to a floor to align the rear end flat seat portion of the front seat to be flush with the front end flat seat portion of the rear seat in the front-rear direction.

According to the first aspect of the disclosure, it is possible to select whether to use both the first seat portion (upper half portion of backrest) of the front seat and the fourth seat portion (ottoman) of the rear seat, neither the first seat portion nor the fourth seat portion, or either the first seat portion or the fourth seat portion. That is, more variations can be provided since the first seat portion and the fourth seat portion can be selectively used in forming a flat seat surface spanning the front seat and the rear seat.

A second aspect of the disclosure provides the seat system according to the first aspect, in which the front seat and the rear seat have the same seat structure including the first seat portion, the second seat portion, the third seat portion, and the fourth seat portion.

According to the second aspect of the disclosure, when the switching by the posture switching mechanism is applied to the third seat portion (seating portion) and the fourth seat portion (ottoman) of the front seat and the second seat portion (backrest lower half portion) and the first seat portion (backrest upper half portion) of the rear seat, it is possible to select whether to use these seat portions as flat seat portions. Therefore, more variations can be provided in forming a flat seat surface spanning the front seat and the rear seat.

A third aspect of the disclosure provides the seat system according to second aspect, in which the posture switching mechanism includes a first coupling portion configured to couple a base end portion of the second seat portion to a base on the floor such that the second seat portion is rotatable about a rotation axis extending in a seat width direction, a second coupling portion configured to couple a base end portion of the third seat portion to the base such that a seat front side relative to the first coupling portion is rotatable about a rotation axis extending in the seat width direction, a third coupling portion configured to couple a base end portion of the first seat portion to a top end portion of the second seat portion such that the first seat portion is rotatable about a rotation axis extending in the seat width direction, and a fourth coupling portion configured to couple a base end portion of the fourth seat portion to a top end portion of the third seat portion such that the fourth seat portion is rotatable about a rotation axis extending in the seat width direction, and the second seat portion and the third seat portion are symmetrical in the front-rear direction, and the first seat portion and the fourth seat portion are symmetrical in the front-rear direction.

According to the third aspect of the disclosure, two types of seat portions may be prepared in implementing the seat system, and the seat system having a simpler and rational structure can be obtained.

A fourth aspect of the disclosure provides the seat system according to third aspect, further including a turning unit configured to support the base such that the base is available to turn about a vertical axis relative to the floor, in which the front-rear slide mechanism supports the turning unit such that the turning unit is slidable in the front-rear direction relative to the floor.

According to the fourth aspect of the disclosure, more variations can be provided since the same seat portions such as the third seat portion (seating portion) of the front seat and the third seat portion (seating portion) of the rear seat can be aligned after the seats are turned by 90 degrees and changed to be arranged sideways.

A fifth aspect of the disclosure provides the seat system according to fourth aspect, further including a second slide mechanism configured to support the base such that the base is slidable relative to the turning unit in the seat front-rear direction, in which the base is slidable in a direction different from a sliding direction of the front-rear slide mechanism by turning together with the second slide mechanism by the turning unit.

According to the fifth aspect of the present disclosure, the seats can slide in the seat front-rear direction even in the middle of turning in which the seats arranged in the front-rear direction are changed to be arranged in the left-right direction, and accordingly it is possible to avoid interference between seat portions.

A sixth aspect of the disclosure provides the seat system according to fourth or fifth aspect, in which the turning unit has the vertical axis serving as a turning center in a position deviated from a center of the front seat and the rear seat in the seat width direction.

According to the sixth aspect of the present disclosure, when the vehicle is turned by 90 degrees, the vertical axis can be closer to a side of the floor than when the vertical axis is in the center in the width direction.

A seventh aspect of the disclosure provides the seat system according to third aspect, in which the posture switching mechanism is available for switching to a folded mode in which the second seat portion and the third seat portion are erected to face each other, and the first seat portion and the fourth seat portion are vertically flush relative to the erected second seat portion and third seat portion.

According to the seventh aspect of the disclosure, a vehicle interior space can be widely used by folding one of the front seat and the rear seat, and thus a more useful seat system can be obtained.

A eighth aspect of the disclosure provides the seat system according to third aspect, in which the posture switching mechanism is available for switching to a table mode in which the second seat portion and the third seat portion are erected to face each other and the first seat portion and the fourth seat portion are flush in the front-rear direction.

According to the eighth aspect of the disclosure, a more useful seat system can be obtained since one of the front seat and the rear seat can be used as a table.

A ninth aspect of the disclosure provides the seat system according to third aspect, in which the posture switching mechanism is available for switching to a reverse mode in which the second seat portion of the front seat is made flat and available to sit and the third seat portion of the front seat is erected to face the rear seat and available as a backrest.

According to the ninth aspect of the disclosure, a more useful seat system can be obtained since persons seated in the front seat and the rear seat can face each other.

### BRIEF DESCRIPTION OF DRAWINGS

FIG. 1 illustrates a front seat and a rear seat in a vehicle interior to which a seat system is applied;

FIG. 2 is a perspective view of the front seat (rear seat);

FIG. 3 is a perspective view of the front seat (rear seat);

FIG. 4 illustrates angle adjustment by a reclining device;

FIG. 5 illustrates combinations of patterns;

FIG. 6 illustrates one of variations of a combine mode;

FIG. 7 illustrates one of variations of the combine mode;

FIG. 8 illustrates one of variations of the combine mode;

FIG. 9 illustrates one of variations of the combine mode;

FIG. 10 illustrates a state in which seats arranged in a front-rear direction are turned by 90 degrees;

FIG. 11 illustrates one of variations of a combine mode;

FIG. 12 illustrates a usage example of a folded mode;

FIG. 13 illustrates a usage example of a table mode; and

FIG. 14 illustrates a usage example of a reverse mode.

### DESCRIPTION OF EMBODIMENTS

The present embodiment will describe an example in which a seat system according to the present disclosure is applied to a seat mounted on a vehicle called a one-box car or a wagon car. In the following description, when a direction such as front, rear, upper, lower, left, and right is referred to, the direction indicates a corresponding direction illustrated in the drawings.

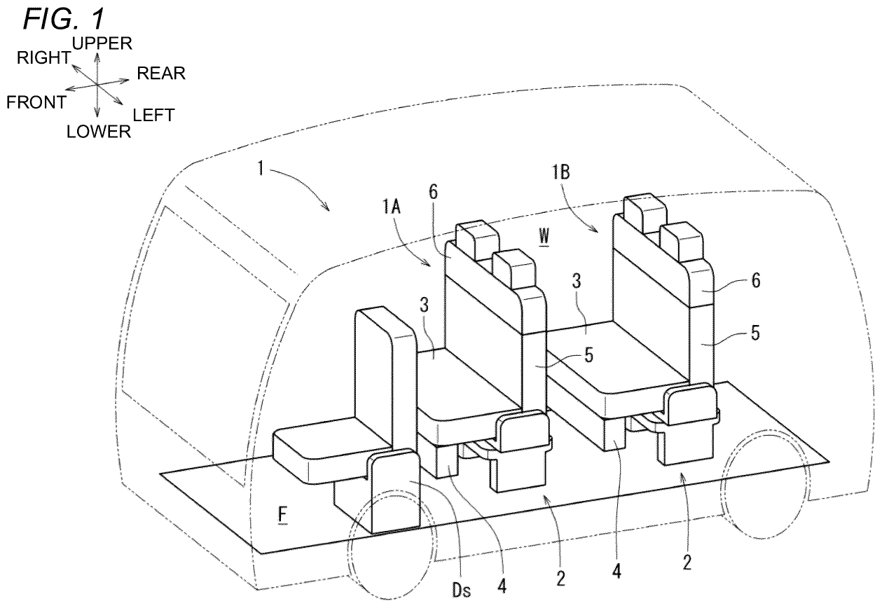

When a direction is referred to with “seat” attached thereto such as “seat width direction” and “seat front-rear direction” the direction indicates a corresponding direction relative to a seating portion 3. In the following description, when no specific reference drawing is referred to or there is no corresponding reference numeral in the reference drawing, any one of FIGS. 1 to 14 is referred to as appropriate.

### First Embodiment

### Outline of Seat System 1

As illustrated in FIG. 1, a seat system 1 according to the present embodiment is applied to a front seat 1A and a rear seat 1B installed in a vehicle interior.

The seat system 1 includes the front seat 1A and the rear seat 1B that are arranged in the front-rear direction. The seats 1A and 1B are each disposed on an interior floor of a vehicle together with a driver seat Ds as a bench seat for two persons. The driver seat Ds is arranged in a first row, the front seat 1A is arranged in a second row, and the rear seat 1B is arranged in a third row.

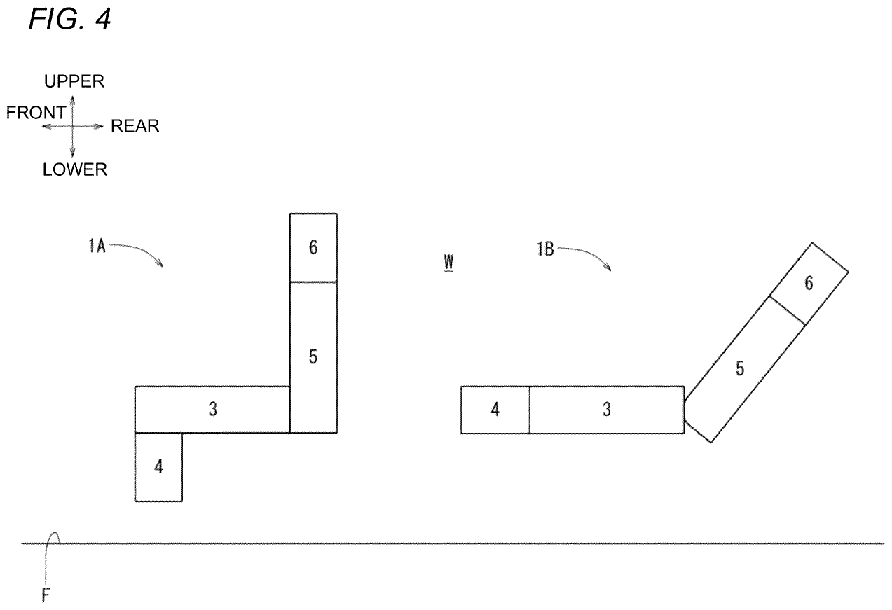

The seats 1A and 1B each include the seating portion 3, an ottoman 4, a backrest lower half portion 5, and a backrest upper half portion 6 (hereinafter collectively referred to as seat portions 3 to 6). Angles of the seat portions 3 to 6 can be adjusted by reclining devices 7a to 7d described later. For example, as illustrated in FIG. 4, the backrest lower half portion 5 and the backrest upper half portion 6 of the front seat 1A (hereinafter, also referred to as the backrests 5 and 6) can be inclined like the backrest lower half portion 5 and the backrest upper half portion 6 of the rear seat 1B, and can further be tilted to be flush with the seating portion 3 of the rear seat 1B. As illustrated in FIG. 4, the folded ottoman 4 of the front seat 1A can be unfolded to be flush with the seating portion 3 as in the rear seat 1B. Only the backrest upper half portion 6 of the backrests 5 and 6 of the front seat 1A can be moved to be folded like the ottoman 4 or be folded in the middle.

The seat system 1 includes front-rear slide mechanisms 2 that slide the seats 1A and 1B in the front-rear direction relative to a floor F. A distance between the seats 1A and 1B can be reduced or increased by the front-rear slide mechanisms 2.

That is, in the front seat 1A and the rear seat 1B to which the seat system 1 is applied, it is possible to use a combine mode in which the front seat 1A and the rear seat 1B are joined (combined) to form a flat seat surface spanning the front seat 1A and the rear seat 1B by adjusting the angles of the seat portions 3 to 6 and sliding the seats 1A and 1B in the front-rear direction.

### Reclining Devices 7a to 7d

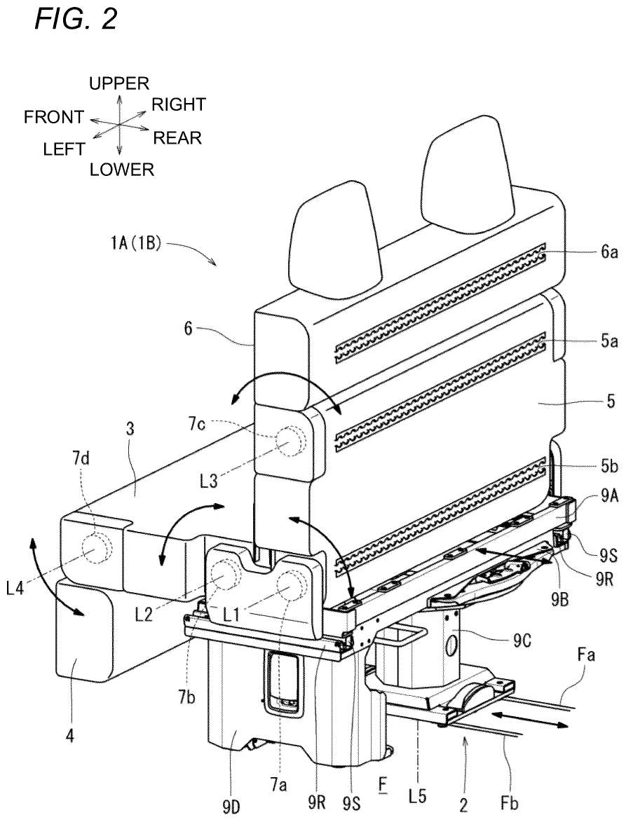

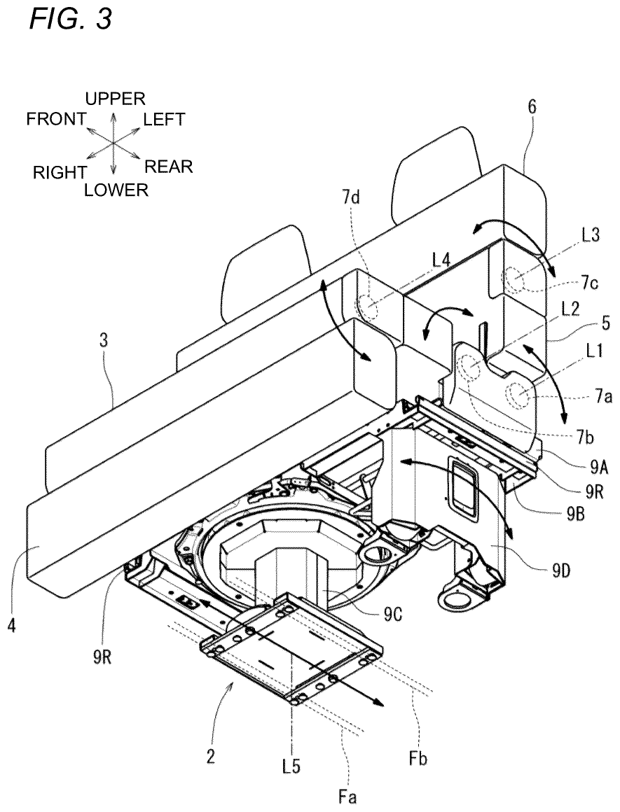

As illustrated in FIGS. 2 and 3, each of the reclining devices 7a to 7d is a device that couples an object to a mating component such that an angle of the object can be adjusted. For example, the reclining device 7a couples a base end portion of the backrest lower half portion 5 to a base 9A such that the backrest lower half portion 5 is rotatable about a rotation axis L1 extending in the seat width direction. In addition, the reclining device 7b couples a base end portion of the seating portion 3 to the base 9A such that a seat front side relative to the reclining device 7a is rotatable about a rotation axis L2 extending in the seat width direction.

The reclining device 7c couples a base end portion of the backrest upper half portion 6 to a top end portion of the backrest lower half portion 5 such that the backrest upper half portion 6 is rotatable about a rotation axis L3 extending in the seat width direction. The reclining device 7d couples a base end portion of the ottoman 4 to a top end portion of the seating portion 3 such that the ottoman 4 is rotatable about a rotation axis L4 extending in the seat width direction.

In the front seat 1A illustrated in FIG. 4, the seating portion 3 is parallel to the floor F, the ottoman 4 is stored below the seating portion 3, and the backrests 5 and 6 are erected. In the front seat 1A, the backrest lower half portion 5 can be tilted by the reclining device 7a until becoming parallel to the floor F. The front seat 1A can be used as a rear end flat seat portion facing the rear seat 1B, and the backrest upper half portion 6 can be folded downward relative to the backrest lower half portion 5 and become flush with the backrest lower half portion 5 again by the reclining device 7c (first switching).

On the other hand, in the rear seat 1B, the seating portion 3 and the ottoman 4 are parallel to the floor F and are flush in the front-rear direction, and the backrests 5 and 6 are flush in the front-rear direction in an inclined state. The rear seat 1B can be used as a front end flat seat portion facing the front seat 1A, and the ottoman 4 can be remained flush with the seating portion 3 and be folded downward relative to the seating portion 3 by the reclining device 7d (second switching).

In this manner, the reclining device 7c and the reclining device 7d constitute a posture switching mechanism that can implement the first switching and the second switching.

### Sliding and Turning of Seats 1A and 1B

As illustrated in FIGS. 2 and 3, the seats 1A and 1B each have a hierarchical structure in which the base 9A to which the seating portion 3 and the backrest lower half portion 5 are coupled, a second slide mechanism 9B that supports the base 9A such that the base 9A is slidable, a turning unit 9C that supports the second slide mechanism 9B such that the second slide mechanism 9B can turn, and the front-rear slide mechanism 2 that allows the turning unit 9C to slide relative to the floor F are arranged in this order from top. The second slide mechanism 9B and the front-rear slide mechanism 2 each include a lock portion that locks a slide movement.

The front-rear slide mechanism 2 located in a lower layer slides an entire respective one of the seats 1A and 1B in the front-rear direction relative to the floor F. On the other hand, the second slide mechanism 9B in an upper layer slides a part of a respective one of the seats 1A and 1B (the base 9A to which the seating portion 3 and the backrest lower half portion 5 are coupled). That is, even when the slide movement by the front-rear slide mechanism 2 is locked, the base 9A can be slid, and thus positions of the seat portions 3 to 6 can be finely adjusted.

The second slide mechanism 9B includes a slide rail 9R and a slider 9S that slides along the slide rail 9R. The slider 9S is fixed to the base 9A, and when the slider 9S moves along the slide rail 9R, the base 9A (the seating portion 3 and the backrest lower half portion 5 coupled to the base 9A) slides in the front-rear direction relative to the floor F, for example.

The turning unit 9C supports the second slide mechanism 9B such that the second slide mechanism 9B can turn about a vertical axis L5 relative to the floor F. Specifically, the turning unit 9C includes a first circular member that receives a load of a respective one of the seats 1A and 1B, and a second circular member that is fitted to the first member and relatively rotates. The second member is fixed to the second slide mechanism 9B, and the second slide mechanism 9B turns by relative rotation of the second member relative to the first member. When the second slide mechanism 9B turns, the base 9A (the seating portion 3 and the backrest lower half portion 5) coupled to the second slide mechanism 9B also turns about the vertical axis L5 relative to the floor F. The vertical axis L5 is set in a position shifted in a width direction from a center of each of the seats 1A and 1B in the seat width direction.

The base 9A (the seating portion 3 and the backrest lower half portion 5) can slide in a direction different from a sliding direction (front-rear direction) of the front-rear slide mechanism 2 by turning together with the second slide mechanism 9B by the turning unit 9C.

A leg portion 9D is integrated with the second slide mechanism 9B and receives a load acting on a respective one of the seats 1A and 1B together with the turning unit 9C. The leg portion 9D also rotates integrally with the second slide mechanism 9B about the vertical axis L5. The leg portion 9D is locked to the floor F when turning of a respective one of the seats 1A and 1B is locked. Specifically, the floor F is provided with one slide rail (not illustrated) in addition to slide rails Fa and Fb, and the leg portion 9D includes two lock portions that can be locked to these slide rails. The lock portions are arranged in a row in the front-rear direction with the leg portion 9D in a state illustrated in FIGS. 2 and 3. For this reason, the leg portion 9D is locked to one slide rail. When the leg portion 9D turns by 90 degrees together with the second slide mechanism 9B, the two lock portions are locked to the slide rails Fa and Fb, respectively.

The front-rear slide mechanism 2 in a lowermost layer allows the turning unit 9C to slide in the front-rear direction relative to the floor F. Specifically, the second slide mechanism 9B includes the slide rails Fa and Fb provided on the floor F and a slide mechanism (not illustrated) provided on a bottom surface of the turning unit 9C.

### Fixing Rail

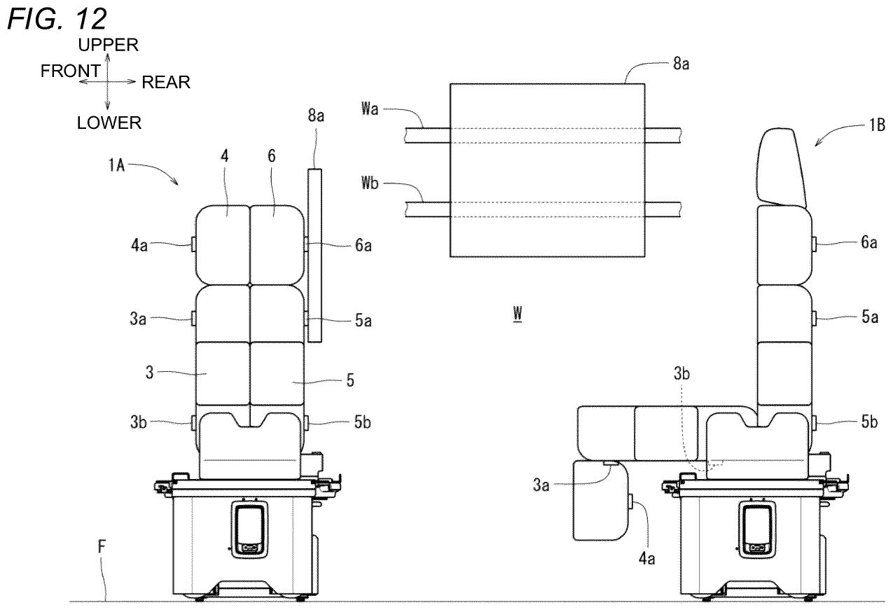

As illustrated in FIG. 2, the seats 1A and 1B are each provided with fixing rails 3a to 6a. As illustrated in FIGS. 12 to 14, fixing rails Wa and Wb are also provided on a wall W in the vehicle interior. The fixing rails 3a to 6a, Wa, and Wb are fixtures for a user to detachably fix other members. Examples of the “other member” include a table, a partition, and a monitor (display).

The fixing rails 3a to 6a are provided at portions other than seat surfaces of the seat portions 3 to 6. For example, the fixing rail 6a is provided on a back surface of the backrest upper half portion 6. The fixing rails 3a to 6a are provided along the seat width direction and are parallel to the floor F.

As illustrated in FIGS. 12 to 14, the fixing rails Wa and Wb are provided along a vehicle front-rear direction and are parallel to the floor F. An interval between the fixing rails Wa and Wb is equal to an interval between the fixing rails 5a and 6a.

Basic structures and usages of the fixing rails 3a to 6a, Wa, and Wb are the same as those disclosed in JP2023-152046A, for example.

### Variations of Combine Mode

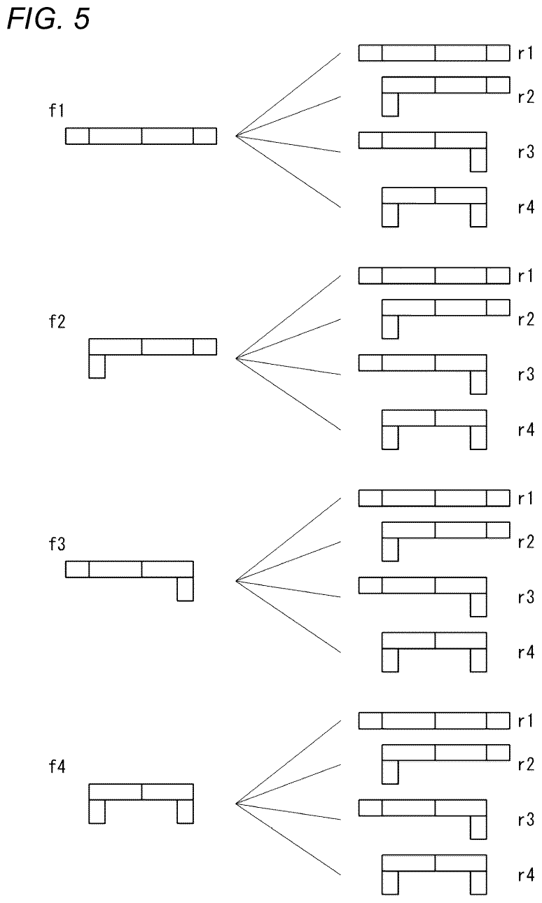

As illustrated in FIG. 5, there are four patterns in which the seat portions 3 to 6 of the front seat 1A are flush. Since there are four patterns of the rear seat 1B for each of the four patterns, it can be said that there are 16 variations in which the seat portions 3 to 6 of the seats 1A and 1B are combined and flush. For example, changing pad hardness or surface layer materials of the seat portions 3 to 6 can provide 16 different hardness and textures in arranging the seat portions 3 to 6 to form a flat seat surface spanning the front seat 1A and the rear seat 1B.

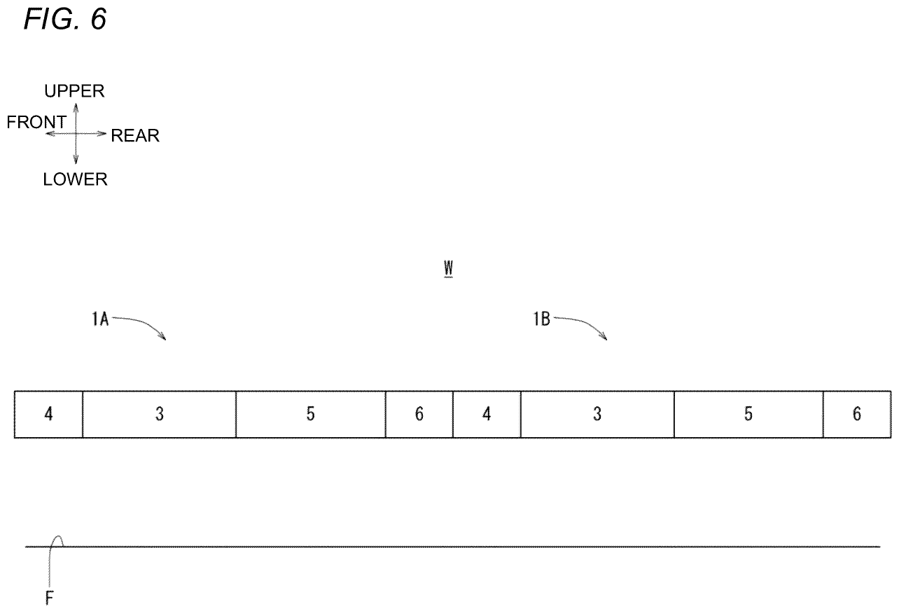

Hereinafter, a part of variations will be described while incorporating operations on the seats 1A and 1B. In FIG. 6, the seat portions 3 to 6 of the seats 1A and 1B are all flush in the front-rear direction. Such a variation is a combination of a pattern f1 and a pattern r1 of combinations illustrated in FIG. 5. This is a longest one of all variations of the combine mode. For example, the backrest upper half portion 6 of the rear seat 1B can be used as a pillow when being slightly lifted upward and fixed. When the backrest lower half portion 5 of the rear seat 1B is slightly lifted up together with the backrest upper half portion 6, it is possible to lie on one's back with an upper body in a slightly raised state. In this manner, the user can appropriately arrange the variations illustrated in FIG. 5.

To switch from a state of the seats 1A and 1B in FIG. 4 to a state of the seats 1A and 1B in FIG. 6, for example, following procedures are performed.

First, the backrest lower half portion 5 of the rear seat 1B is tilted until becoming parallel to the floor F. Since the backrest upper half portion 6 is already flush with the backrest lower half portion 5, the backrest upper half portion 6 is parallel to the floor F together with the backrest lower half portion 5. Next, the ottoman 4 of the front seat 1A is unfolded to be flush with the seating portion 3. Next, the backrests 5 and 6 of the front seat 1A are tilted until becoming parallel to the floor F. However, the backrests 5 and 6 of the front seat 1A would interfere with the rear seat 1B when directly tilted. Therefore, a distance between the front seat 1A and the rear seat 1B is increased using the front-rear slide mechanism 2. Finally, the backrest upper half portion 6 of the front seat 1A and the ottoman 4 of the rear seat 1B are finely adjusted to be arranged without a gap.

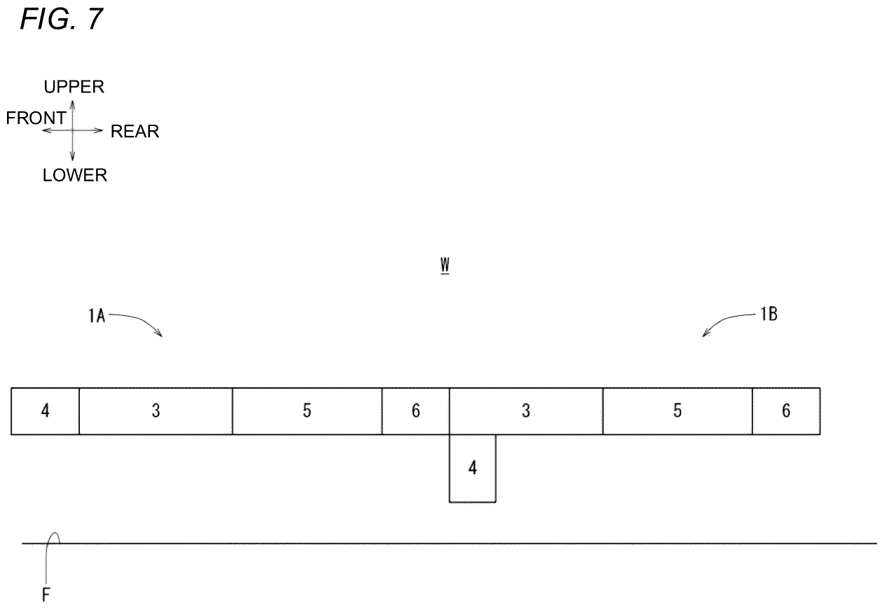

In FIG. 7, the seat portions 3 to 6 of the seats 1A and 1B (excluding the ottoman 4 of the rear seat 1B) are flush in the front-rear direction. Such a variation is a combination of the pattern f1 and a pattern r2 of the combinations illustrated in FIG. 5. To switch from the state of FIG. 6 to a state of FIG. 7, for example, following procedures are performed.

First, the ottoman 4 of the rear seat 1B is folded downward relative to the seating portion 3. Next, the backrest upper half portion 6 of the seat 1A and the seating portion 3 of the rear seat 1B are finely adjusted to be arranged without a gap using the front-rear slide mechanism 2. The second slide mechanism 9B may be used for the fine adjustment.

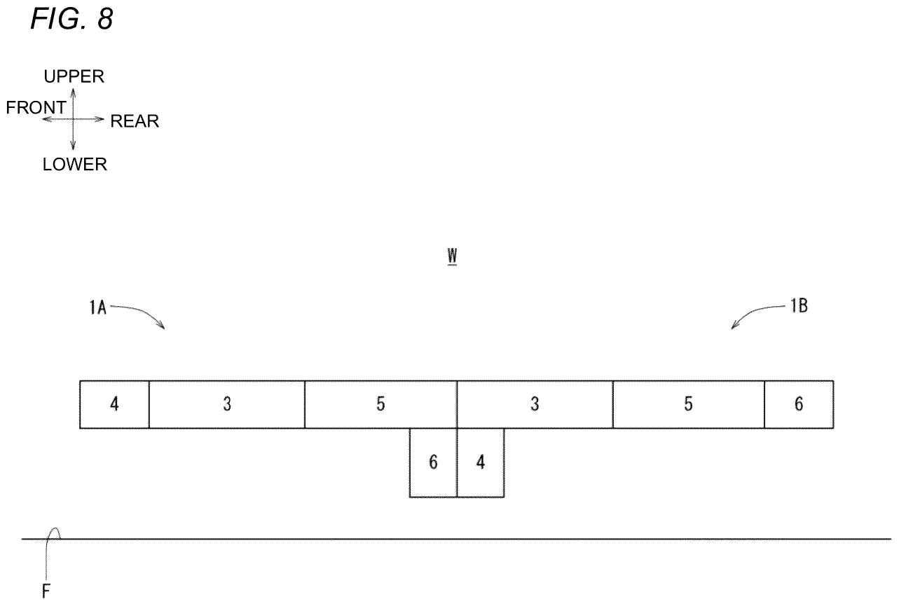

In FIG. 8, the seating portions 3, the ottoman 4 (except the ottoman 4 of the rear seat 1B), the backrest lower half portions 5, and the backrest upper half portion 6 (except the backrest upper half portion 6 of the front seat 1A) of the seats 1A and 1B are flush in the front-rear direction. Such a variation is a combination of a pattern f3 and the pattern r2 of the combinations illustrated in FIG. 5. To switch from the state of FIG. 7 to a state of FIG. 8, for example, following procedures are performed.

First, the backrest upper half portion 6 of the front seat 1A is folded downward relative to the backrest lower half portion 5. The fine adjustment to fill a gap is as described above.

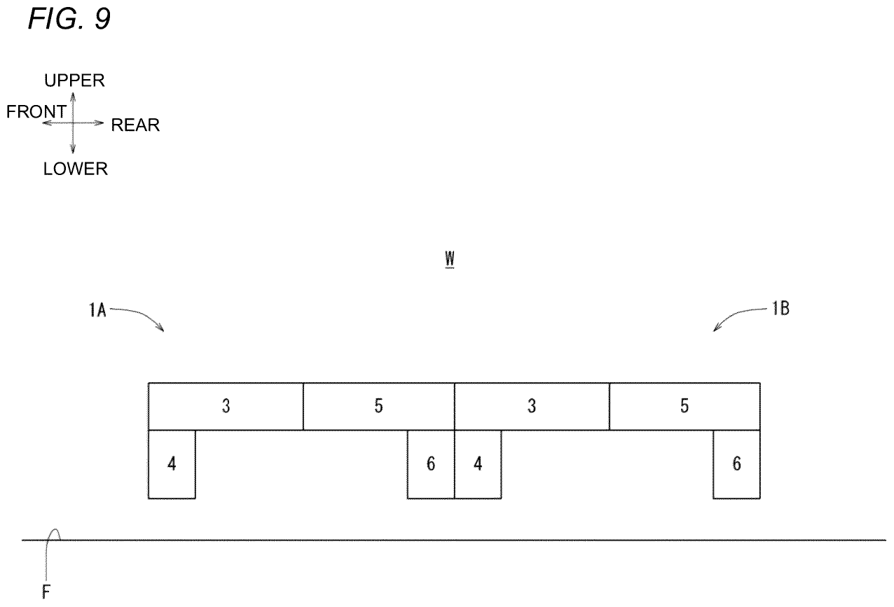

In FIG. 9, the seating portions 3 and the backrest lower half portions 5 of the seats 1A and 1B are flush in the front-rear direction. Such a variation is a combination of a pattern f4 and a pattern r4 of the combinations illustrated in FIG. 5. To switch from the state of FIG. 8 to a state of FIG. 9, the ottoman 4 of the front seat 1A is folded downward relative to the seating portion 3, and the backrest upper half portion 6 of the rear seat 1B is folded downward relative to the backrest lower half portion 5.

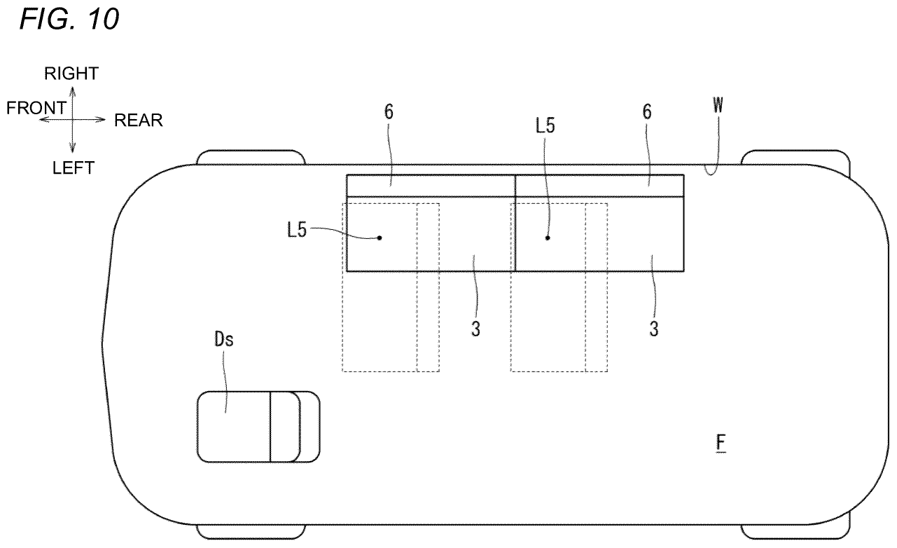

When the seats 1A and 1B are turned by 90 degrees and are arranged in a row in the front-rear direction and face sideways such that a seat front-rear direction is orthogonal to the vehicle front-rear direction, the variations in which the seat portions 3 to 6 are flush are further increased. That is, as illustrated in FIG. 10, the seats 1A and 1B can be turned about the vertical axis L5 by the turning unit 9C from a state (dotted line) in which the seats 1A and 1B are arranged in the front-rear direction and shifted to a state (solid line) in which the seats 1A and 1B face sideways and are arranged in a row in the front-rear direction. Hereinafter, a part of variations when the seats 1A and 1B face sideways and are arranged in a row in the front-rear direction will be described while incorporating operations on the seats 1A and 1B.

The seats 1A and 1B are close to the wall W in the vehicle interior after turning by 90 degrees. This is based on a setting of the vertical axis L5 in a position deviated from a center in the seat width direction. As a result of deviating from the center, the vertical axis L5 is located closer to the wall W. When set in the center in the seat width direction, the vertical axis L5 is away from the wall W in the vehicle interior after turning by 90 degrees. Accordingly, the vertical axis L5 needs to be slid using, for example, the second slide mechanism 9B to approach the wall W in the vehicle interior.

Further, that the seats 1A and 1B are arranged without a gap after turning by 90 degrees is based on a sliding movement by the second slide mechanism 9B. If the sliding movement by the second slide mechanism 9B cannot be performed, the backrest lower half portion 5 of the front seat 1A interferes with the seating portion 3 of the rear seat 1B during turning when a positional relationship between the seats 1A and 1B before turning is to be arranged without a gap after turning by 90 degrees (a distance between the vertical axes L5 of the seats 1A and 1B before and after turning does not change). However, when the second slide mechanism 9B is used, the front seat 1A can be slid to avoid the rear seat 1B when interference is about to occur.

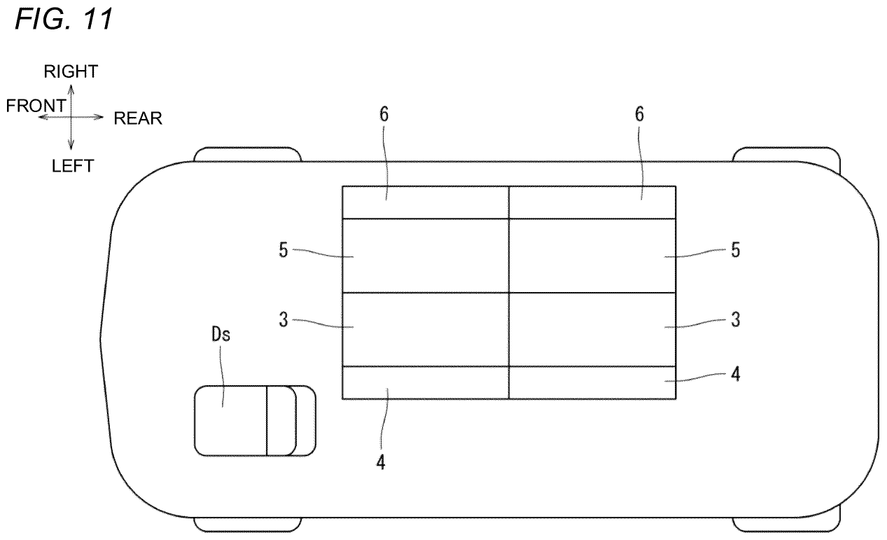

FIG. 11 illustrates a state in which the seat portions 3 to 6 of the seats 1A and 1B are all flush. To switch from a state of FIG. 10 to a state of FIG. 11, for example, following procedures are performed.

Since there is no space between the seats 1A and 1B and the wall W for tilting the backrests 5 and 6, the seat portions 3 to 6 are first slid leftward together with the base 9A using the second slide mechanism 9B. After the space is ensured, the backrest lower half portion 5 is tilted until becoming parallel to the floor F. The backrest upper half portion 6 is also appropriately adjusted to be flush with the backrest lower half portion 5. Finally, the ottoman 4 is unfolded to be flush with the seating portion 3.

In FIG. 11, a width in the left-right direction is maximum, and a length of the width can be appropriately adjusted. Specifically, the width in the left-right direction can be changed when the backrest upper half portions 6 and the ottomans 4 of the seats 1A and 1B are folded downward or erected. For example, when the ottomans 4 of the seats 1A and 1B are folded downward from the state illustrated in FIG. 11, the width can be narrowed accordingly. Conversely, when the ottomans 4 of the seats 1A and 1B are erected, the ottomans 4 can be used as a bed guard for preventing falling in addition to the narrowed width. Further, both the backrest upper half portion 6 and the ottoman 4 may be erected so that a bed guard is provided on both sides. Further, both the backrest upper half portion 6 and the ottoman 4 may be folded downward.

### Other Modes

In the seat system 1, in addition to the combine mode in which the seat portions 3 to 6 of the seats 1A and 1B are arranged to form a flat seat surface, other modes can be used by deforming the front seat 1A as illustrated in FIGS. 12 to 14, and a highly convenient vehicle interior space can be provided.

In FIG. 12, the front seat 1A is in a folded mode. The folded mode is a mode in which the seating portion 3 and the backrest lower half portion 5 are erected to face each other, and the ottoman 4 and the backrest upper half portion 6 are vertically flush with the erected seating portion 3 and backrest lower half portion 5.

By setting the front seat 1A in the folded mode and sliding the front seat 1A forward, a seated person in the rear seat 1B can use a wide space.

An object 8a such as a monitor can be fixed to the fixing rails 5a and 6a of the front seat 1A. By fixing the object 8a to the two fixing rails in this manner, the object 8a can be more firmly fixed as compared with a case where the object 8a is fixed to one fixing rail.

As described above, the interval between the fixing rails 5a and 6a is the same as the interval between the fixing rails Wa and Wb. For this reason, the object 8a can be fixed to the fixing rails Wa and Wb of the wall W instead of the fixing rails 5a and 6a.

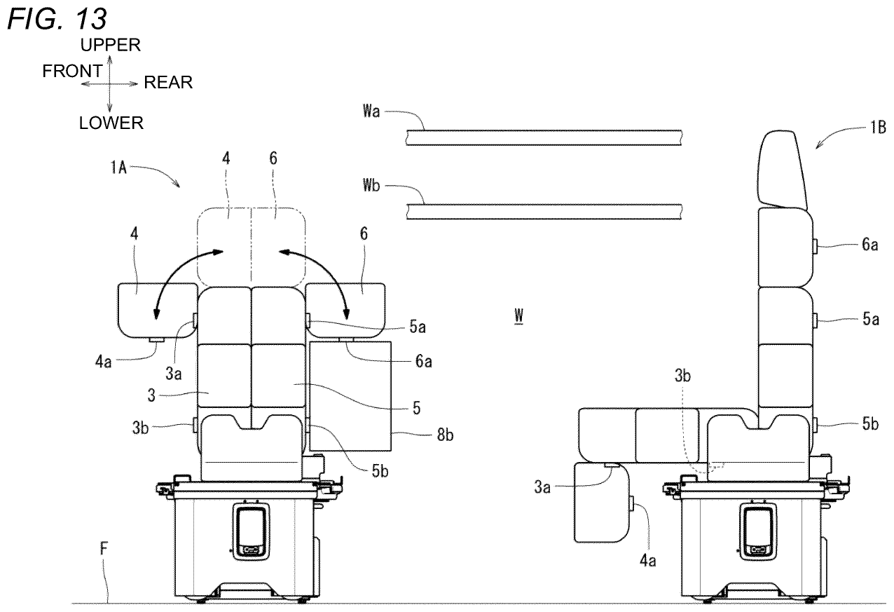

In FIG. 13, the front seat 1A is in a table mode. The table mode is a mode in which the seating portion 3 and the backrest lower half portion 5 are erected to face each other, and the ottoman 4 and the backrest upper half portion 6 are flush in the front-rear direction. That is, when the ottoman 4 and the backrest upper half portion 6 are unfolded from the folded mode, the folded mode is switched to the table mode.

By setting the front seat 1A to the table mode, the seated person in the rear seat 1B can place luggage on an upper portion of the front seat 1A. By fixing an object 8b to the fixing rail 6a, the object 8b can be held to hang down from the backrest upper half portion 6. When the object 8b is also fixed to the fixing rail 5a, the object 8b can be more firmly fixed.

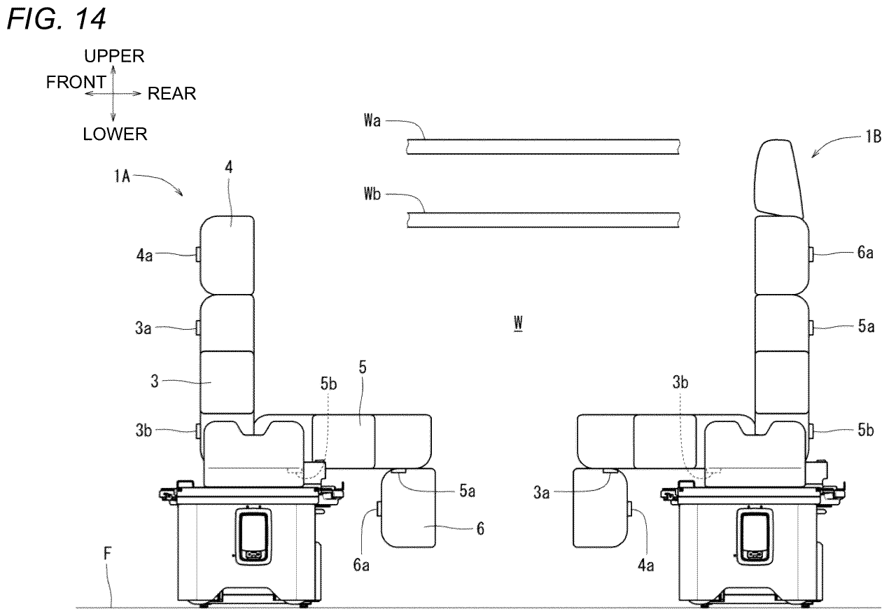

In FIG. 14, the front seat 1A is in a reverse mode. The reverse mode is a mode in which the backrest lower half portion 5 of the front seat 1A is inclined to be parallel to the floor F and is available to sit, and the seating portion 3 of the front seat 1A is erected to face the rear seat 1B and is available as a backrest.

By setting the front seat 1A in the reverse mode, persons seated in the front seat 1A and the rear seat 1B can face each other, and thus a highly convenient vehicle interior space can be provided. For example, when a monitor is fixed to the fixing rails Wa and Wb, the persons in the seats 1A and 1B can see the monitor.

To summarize the above, a seat system (1) according to the present embodiment has following configurations. In the following description, reference numerals assigned in parentheses correspond to configurations described in the embodiment described above.

That is, the seat system (1) includes a front seat (1A) and a rear seat (1B) that are arranged in a front-rear direction. The seat system (1) includes a posture switching mechanism (7c, 7d) configured to implement a first switching for selectively switching to a rear end flat seat portion facing the rear seat (1B) by making a first seat portion (6) constituting an upper half portion of a backrest of the front seat (1A) flush with a second seat portion (5) constituting a lower half portion of the backrest in the front-rear direction and folding the first seat portion (6) downward relative to the flat second seat portion (5), and a second switching for selectively switching to a front end flat seat portion facing the front seat (1A) by making a third seat portion (3) constituting a seating portion of the rear seat (1B) flush with a fourth seat portion (4) constituting an ottoman in the front-rear direction and folding the fourth seat portion (4) downward relative to the flat third seat portion (3). The seat system (1) further includes a front-rear slide mechanism (2) configured to slide the front seat (1A) and/or the rear seat (1B) in the front-rear direction relative to a floor (F) to align the rear end flat seat portion of the front seat (1A) to be flush with the front end flat seat portion of the rear seat (1B) in the front-rear direction.

According to the above configuration, it is possible to select whether to use both the first seat portion (6) of the front seat (1A) and the fourth seat portion (4) of the rear seat (1B), neither the first seat portion (6) nor the fourth seat portion (4), or either the first seat portion (6) or the fourth seat portion (4). That is, more variations can be provided since the first seat portion (6) and the fourth seat portion (4) can be selectively used in forming a seat surface spanning the front seat (1A) and the rear seat (1B).

The front seat (1A) and the rear seat (1B) have the same seat structure including the first seat portion (6), the second seat portion (5), the third seat portion (3), and the fourth seat portion (4). According to the above configuration, when the switching by the posture switching mechanism (7c, 7d) is applied to the third seat portion (3) and the fourth seat portion (4) of the front seat (1A) and the second seat portion (5) and the first seat portion (6) of the rear seat (1B), it is possible to select whether to use these seat portions as flat seat portions. Therefore, more variations can be provided in forming a seat surface spanning the front seat (1A) and the rear seat (1B).

The posture switching mechanism includes a first coupling portion (7a) configured to couple a base end portion of the second seat portion (5) to a base (9A) on the floor (F) such that the second seat portion (5) is rotatable about a rotation axis (L1) extending in a seat width direction, a second coupling portion (7b) configured to couple a base end portion of the third seat portion (3) to the base (9A) such that a seat front side relative to the first coupling portion (7a) is rotatable about a rotation axis (L2) extending in the seat width direction, a third coupling portion (7c) configured to couple a base end portion of the first seat portion (6) to a top end portion of the second seat portion (5) such that the first seat portion (6) is rotatable about a rotation axis (L3) extending in the seat width direction, and a fourth coupling portion (7d) configured to couple a base end portion of the fourth seat portion (4) to a top end portion of the third seat portion (3) such that the fourth seat portion (4) is rotatable about a rotation axis (L4) extending in the seat width direction, the second seat portion (5) and the third seat portion (3) are symmetrical in the front-rear direction, and the first seat portion (6) and the fourth seat portion (4) are symmetrical in the front-rear direction.

According to the above configuration, two types of seat portions may be prepared in implementing the seat system (1), and the seat system (1) having a simpler and rational structure can be obtained.

The seat system (1) further includes a turning unit (9C) configured to support the base (9A) such that the base (9A) is available to turn about a vertical axis (L5) relative to the floor (F), and the front-rear slide mechanism (2) supports the turning unit (9C) such that the turning unit (9C) is slidable in the front-rear direction relative to the floor (F). According to the above configuration, more variations can be provided since the same seat portions such as the third seat portion (3) of the front seat (1A) and the third seat portion (3) of the rear seat (1B) can be aligned after the seats are turned by 90 degrees and changed to be arranged sideways.

The seat system (1) further includes a second slide mechanism (9B) configured to support the base (9A) such that the base (9A) is slidable relative to the turning unit (9C) in the seat front-rear direction, and the base (9A) is slidable in a direction different from a sliding direction of the front-rear slide mechanism (2) by turning together with the second slide mechanism (9B) by the turning unit (9C). According to the above configuration, the seats (1A, 1B) can slide in the seat front-rear direction even in the middle of turning in which the seats (1A, 1B) arranged in the front-rear direction are changed to be arranged in the left-right direction, and accordingly it is possible to avoid interference between seat portions.

In the fourth or fifth aspect of the disclosure, the turning unit (9C) has the vertical axis (L5) serving as a turning center in a position deviated from a center of each of the front seat (1A) and the rear seat (1B) in the seat width direction. According to the above configuration, when the vehicle is turned by 90 degrees, the vertical axis (L5) can be closer to a side of the floor (F) than when the vertical axis (L5) is in the center in the width direction.

The posture switching mechanism is available for switching to a folded mode in which the second seat portion (5) and the third seat portion (3) are erected to face each other, and the first seat portion (6) and the fourth seat portion (4) are vertically flush with the erected second seat portion (5) and third seat portion (3). According to the above configuration, a vehicle interior space can be widely used by folding one of the front seat (1A) and the rear seat (1B), and thus a more useful seat system (1) can be obtained.

The posture switching mechanism is available for switching to a table mode in which the second seat portion (5) and the third seat portion (3) are erected to face each other and the first seat portion (6) and the fourth seat portion (4) are flush in the front-rear direction. According to the above configuration, a more useful seat system (1) can be obtained since one of the front seat (1A) and the rear seat (1B) can be used as a table.

The posture switching mechanism is available for switching to a reverse mode in which the second seat portion (5) of the front seat (1A) is made flat and available to sit, and the third seat portion (3) of the front seat (1A) is erected to face the rear seat (1B) and available as a backrest. According to the above configuration, a more useful seat system (1) can be obtained since persons seated in the front seat (1A) and the rear seat (1B) can face each other.

### OTHER EMBODIMENTS

Embodiments according to the present disclosure have been described with reference to one embodiment, whereas the present disclosure can be implemented in various forms other than the above embodiment.

1. In the above embodiment, seat portions used in the combine mode include the seating portion 3 and the ottoman 4 of the front seat 1A and the backrest lower half portion 5 and the backrest upper half portion 6 of the rear seat 1B. However, in forming a flat seat surface spanning the front seat 1A and the rear seat 1B, at least the backrest lower half portion 5 and the backrest upper half portion 6 of the front seat 1A and the seating portion 3 and the ottoman 4 of the rear seat 1B may be used. Even in this case, there are two patterns of making the backrest upper half portion 6 flush with the backrest lower half portion 5 of the front seat 1A and folding the backrest upper half portion 6 relative to the backrest lower half portion 5 and two patterns of making the ottoman 4 flush with the seating portion 3 of the rear seat 1B and folding the ottoman 4 relative to the seating portion 3, and thus four variations can be provided as combinations. In terms of the four variations, the seating portion 3 and the ottoman 4 of the front seat 1A and the backrest lower half portion 5 and the backrest upper half portion 6 of the rear seat 1B can be freely arranged by adjusting angles thereof. For example, the seating portion 3 and the ottoman 4 of the front seat 1A may be in an erected state, and the backrest lower half portion 5 and the backrest upper half portion 6 of the rear seat 1B may be flush in the front-rear direction (vice versa). Further, the seating portion 3 and the ottoman 4 of the front seat 1A and the backrest lower half portion 5 and the backrest upper half portion 6 of the rear seat 1B may be all in an erected state (may also be inclined at, for example, 45 degrees instead of the erected state). The 16 variations illustrated in FIG. 5 can also be regarded as a special mode (bed mode in which selected seat portions are flush) in the combine mode.

2. In the above embodiment, the seating portion 3 and the ottoman 4 of the front seat 1A have the same configurations as the seating portion 3 and the ottoman 4 of the rear seat 1B, and may also have different configurations. For example, the front seat 1A may not include the ottoman 4. An angle of the seating portion 3 may not be adjustable. Similarly, the backrest lower half portion 5 and the backrest upper half portion 6 of the rear seat 1B have the same configurations as the backrest lower half portion 5 and the backrest upper half portion 6 of the front seat 1A, and may also have different configurations. For example, the rear seat 1B may not include the backrest upper half portion 6. An angle of the backrest lower half portion 5 may not be adjustable.

3. In the above embodiment, both the front seat 1A and the rear seat 1B are slidable in the front-rear direction. Alternatively, only one of the front seat 1A and the rear seat 1B may be slidable in the front-rear direction.

4. In the above embodiment, the seating portion 3 and the backrest lower half portion 5 are symmetrical to each other, and the ottoman 4 and the backrest upper half portion 6 are also symmetrical to each other. Alternatively, asymmetrical is also possible. For example, the backrest lower half portion 5 may be longer than the seating portion 3 in the front-rear direction, or the backrest upper half portion 6 may be longer than the ottoman 4 in the front-rear direction.

5. In the above embodiment, the seats 1A and 1B can be turned by the turning unit 9C. Alternatively, the turning unit 9C may not be provided. Further, the seat system may include only one of the front-rear slide mechanism 2 and the second slide mechanism 9B as long as the seat system can slide in the front-rear direction to eliminate the gap between the front seat 1A and the rear seat 1B.

6. In the above embodiment, the vertical axis L5 is set in a position deviated from the center in the seat width direction, and may also be set in the center in the seat width direction.

7. In the above embodiment, the seat system is applied to the front seat 1A and the rear seat 1B mounted on a vehicle, but the seat system is not limited to a floor in a vehicle interior, and can be applied to, for example, a front seat and a rear seat arranged in the front-rear direction on a floor in a building or an outdoor floor.

What is claimed is:

1. A seat system comprising:
a front seat including a first seat portion constituting an upper half portion of a backrest and a second seat portion constituting a lower half portion of the backrest;
a rear seat arranged in a front-rear direction, and including a third seat portion constituting a seating portion and a fourth seat portion constituting an ottoman;
a posture switching mechanism configured to implement:
a first switching for selectively switching to a rear end flat seat portion of the front seat facing the rear seat by making the first seat portion of the front seat flush with the second seat portion of the front seat in the front-rear direction and folding the first seat portion downward relative to the second seat portion; and
a second switching for selectively switching to a front end flat seat portion of the rear seat facing the front seat by making the third seat portion of the rear seat flush with the fourth seat portion in the front-rear direction and folding the fourth seat portion downward relative to the flat third seat portion; and
a front-rear slide mechanism configured to slide at least one of the front seat and the rear seat in the front-rear direction relative to a floor to align the rear end flat seat portion of the front seat to be flush with the front end flat seat portion of the rear seat in the front-rear direction.

2. The seat system according to claim 1, wherein
the front seat and the rear seat have the same seat structure including the first seat portion, the second seat portion, the third seat portion, and the fourth seat portion.

3. The seat system according to claim 2, wherein
the posture switching mechanism includes
a first coupling portion configured to couple a base end portion of the second seat portion to a base on the floor such that the second seat portion is rotatable about a rotation axis extending in a seat width direction,
a second coupling portion configured to couple a base end portion of the third seat portion to the base such that a seat front side relative to the first coupling portion is rotatable about a rotation axis extending in the seat width direction,
a third coupling portion configured to couple a base end portion of the first seat portion to a top end portion of the second seat portion such that the first seat portion is rotatable about a rotation axis extending in the seat width direction, and
a fourth coupling portion configured to couple a base end portion of the fourth seat portion to a top end portion of the third seat portion such that the fourth seat portion is rotatable about a rotation axis extending in the seat width direction, and
the second seat portion and the third seat portion are symmetrical in the front-rear direction, and the first seat portion and the fourth seat portion are symmetrical in the front-rear direction.

4. The seat system according to claim 3, further comprising:
a turning unit configured to support the base such that the base is available to turn about a vertical axis relative to the floor, wherein
the front-rear slide mechanism supports the turning unit such that the turning unit is slidable in the front-rear direction relative to the floor.

5. The seat system according to claim 4, further comprising:
a second slide mechanism configured to support the base such that the base is slidable relative to the turning unit in the seat front-rear direction, wherein
the base is slidable in a direction different from a sliding direction of the front-rear slide mechanism by turning together with the second slide mechanism by the turning unit.

6. The seat system according to claim 4, wherein
the turning unit has the vertical axis serving as a turning center in a position deviated from a center of the front seat and the rear seat in the seat width direction.

7. The seat system according to claim 5, wherein
the turning unit has the vertical axis serving as a turning center in a position deviated from a center of the front seat and the rear seat in the seat width direction.

8. The seat system according to claim 3, wherein
the posture switching mechanism is available for switching to a folded mode in which the second seat portion and the third seat portion are erected to face each other, and the first seat portion and the fourth seat portion are vertically flush relative to the erected second seat portion and third seat portion.

9. The seat system according to claim 3, wherein the posture switching mechanism is available for switching to a table mode in which the second seat portion and the third seat portion are erected to face each other and the first seat portion and the fourth seat portion are flush in the front-rear direction.

10. The seat system according to claim 3, wherein
the posture switching mechanism is available for switching to a reverse mode in which the second seat portion of the front seat is made flat and available to sit and the third seat portion of the front seat is erected to face the rear seat and available as a backrest.
